(19) United States
(12) Patent Application Publication
(10) Pub. No.: US 2013/0304632 A1
(43) Pub. Date: Nov. 14, 2013

(54) SYSTEMS AND METHODS FOR AN ONLINE PAYMENT SYSTEM WITH A DEMURRAGE CHARGE

(71) Applicant: Tariq Fazlay Munif, London (GB)

(72) Inventor: Tariq Fazlay Munif, London (GB)

(21) Appl. No.: 13/470,684

(22) Filed: May 14, 2012

(51) Int. Cl. G06Q 20/10

(52) U.S. Cl. 705/39

(57) ABSTRACT

A system and method to control an online payment system are disclosed. A user account of the online payment system may be subjected to a demurrage charge and a cash-out charge. In some embodiments, the demurrage charge is based on a percentage of the amount of funds currently deposited in the user account. The demurrage charge may be applied to the user account at a particular time interval or unit of time. The cash out charge may be applied to funds that are transferred out of the user account to an external account that is not controlled by the online payment system. In some embodiments, the demurrage charge may encourage frequency of transactions between users as well as increasing networks of users. Moreover, transactions between users involving transfer of funds between user accounts controlled by the online payment system may not be subject to fees.

### FIELD

The present disclosure relates to systems and methods for an online payment system.

### BACKGROUND

Conventional online payment systems are designed with a financial banking model that is designed to reward larger merchants or users. For example, merchants or users with a large amount of revenue may pay a lesser commission or fee than merchants or users with a smaller amount of revenue. As such, conventional online payment system models may benefit larger merchants or users and provide relative disadvantages to smaller merchants or users.

As such, it is desirable to develop systems and methods for an online payment system with an innovative fee structure. For example, as disclosed herein, implementing an online payment system with a demurrage charge may reward merchants or users of the online payment system based on more than the size or revenue associated with the merchants or users.

### SUMMARY

The present disclosure sets forth systems and methods for an online payment system with a demurrage charge.

The systems or methods may be used to implement an online payment system. The systems or methods identify a user account associated with a first amount of funds. In some embodiments, a unit of time for holding the funds may be defined. If the unit of time has been reached, then a demurrage charge is calculated for the user account. In some embodiments, the demurrage charge may be at least partly based on a percentage of the first amount of funds deposited in the user account. The demurrage charge may be subtracted from the first amount of funds of the user account.

In some embodiments, the subtracted demurrage charge may be transferred from the user account to a system account associated with an administrator of the online payment system.

In some embodiments, the systems and methods may receive a notice to transfer the first amount of funds from the user account to an external account. A transfer charge to transfer the first amount of funds to the external account may be determined. In some embodiments, the transfer charge may be subtracted from the first amount of funds to calculate an amount of funds to transfer to the external account.

In some embodiments, the transfer charge is larger than the demurrage charge. In the same or alternative embodiments, transfers between user accounts are not subject to any such charge.

In some embodiments, the systems and methods may receive a request to transfer funds from the user account to a second account. The transfer charge may be applied to the transfer of funds if the second account is an external account that is not controlled by the online payment system. Moreover, no charge is applied to the transfer of funds if the second account is an account controlled by the online payment system.

In some embodiments, the unit of time comprises a particular date.

In some embodiments, the unit of time comprises an amount of time that the first amount of funds has been deposited in the user account.

### BRIEF DESCRIPTION OF THE DRAWINGS

The novel features of the disclosure are set forth in the appended claims. However, for purpose of explanation, several embodiments of the disclosure are set forth in the following figures.

FIG. 1 is a flow diagram of an example method for an online payment system based on a demurrage charge.

FIG. 2 is a flow diagram of an example method to apply a demurrage charge to at least one user account of an online payment system in accordance with some embodiments.

FIG. 3 illustrates a flow diagram of an example method for an online payment system comprising a demurrage charge and cash out charge in accordance with some embodiments of the disclosure.

FIG. 4 is a flow diagram of an example method to issue a credit in the form of a redeemable voucher in accordance with some embodiments.

FIG. 5 illustrates an example method to issue a credit from a buyer to a seller in accordance with some embodiments of the disclosure.

FIG. 6 is an example of transfer of credits in accordance with some embodiments of the disclosure.

FIG. 7 is a flow diagram of an example method to determine debt relationships in accordance with some embodiments.

FIG. 8 illustrates an example environment of an online payment system environment within which some embodiments of the disclosure are implemented.

FIG. 9 depicts a diagram illustrating an exemplary computing system for execution of the operations comprising various embodiments of the disclosure.

### DETAILED DESCRIPTION

The systems and methods disclosed herein relate to an online payment system with a demurrage charge.

In the following detailed description, numerous specific details are set forth in order to provide a thorough understanding of the present disclosure. However, it will become obvious to those skilled in the art that the present disclosure may be practiced without these specific details. The description and representation herein are the common means used by those experienced or skilled in the art to most effectively convey the substance of their work to others skilled in the art. In other instances, well known methods, procedures, and systems have not been described in detail to avoid unnecessarily obscuring aspects of the present disclosure.

The disclosure that follows is divided into five sections. Section I describes systems and methods for an online payment system with a demurrage charge. Section II describes some, but not all, advantages for an online payment system with a demurrage charge. Section III describes an online payment system with credit notes. Section IV describes some, but not all, advantages for an online payment system with credit notes. Section V describes an environment in which some embodiments of the present disclosure may operate.

I. Online Payment System with a Demurrage Charge

In general, the techniques disclosed herein are for use for am online payment system environment. The online payment system implements a marketplace for buyers and sellers to make transactions (e.g., purchases or sales), and the funds associated with the transactions are placed into user accounts managed by the online payment system.

The marketplace may allow a plurality of buyers to place transactions with each other. For example, the transactions may be between any users of the online payment system. In some embodiments, the buyers may make the transactions by using credit notes from a credit account, from a user account managed by the online payment system, or an external account that is not managed by the online payment system (e.g., a conventional fractional reserve bank such as a user's external conventional bank account). As such, buyers may pay for a transaction at the marketplace by using credit notes, funds from a user account managed by the online payment system, or funds from an external account. In some embodiments, funds received to pay for transactions may be deposited into the user accounts. In some embodiments, funds deposited in the user accounts may be subject to a demurrage charge and/or a cash out charge.

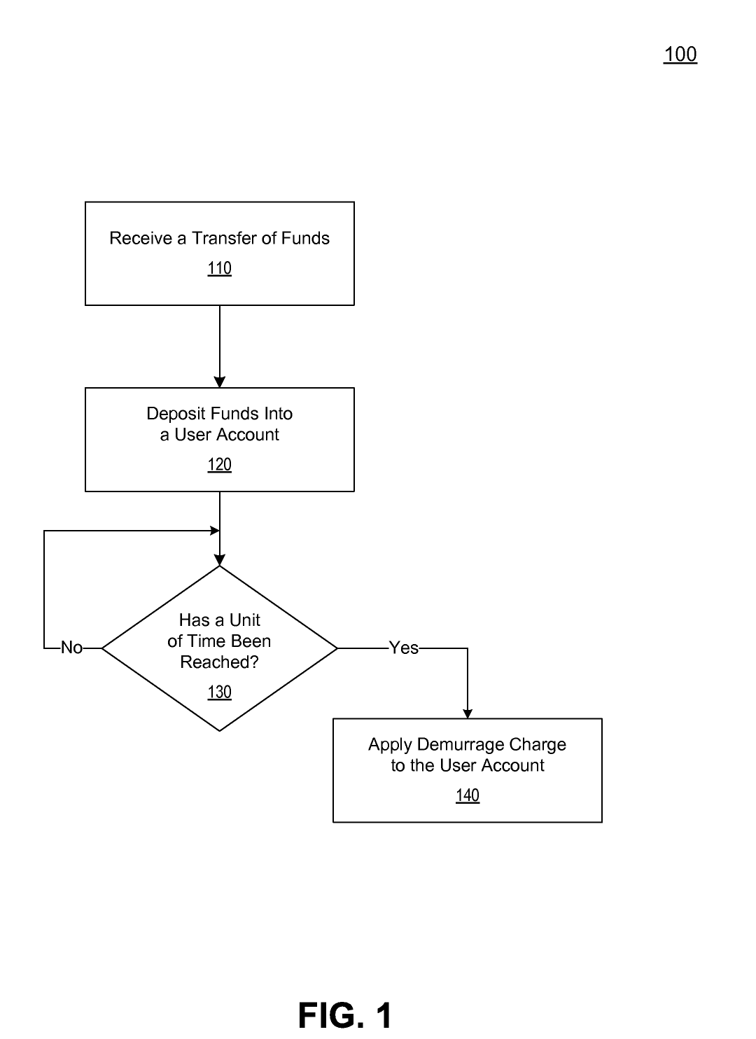

FIG. 1 is a flow diagram of a method 100 for an online payment system based on a demurrage charge. In general, the method 100 may deduct a demurrage charge from funds of a user account.

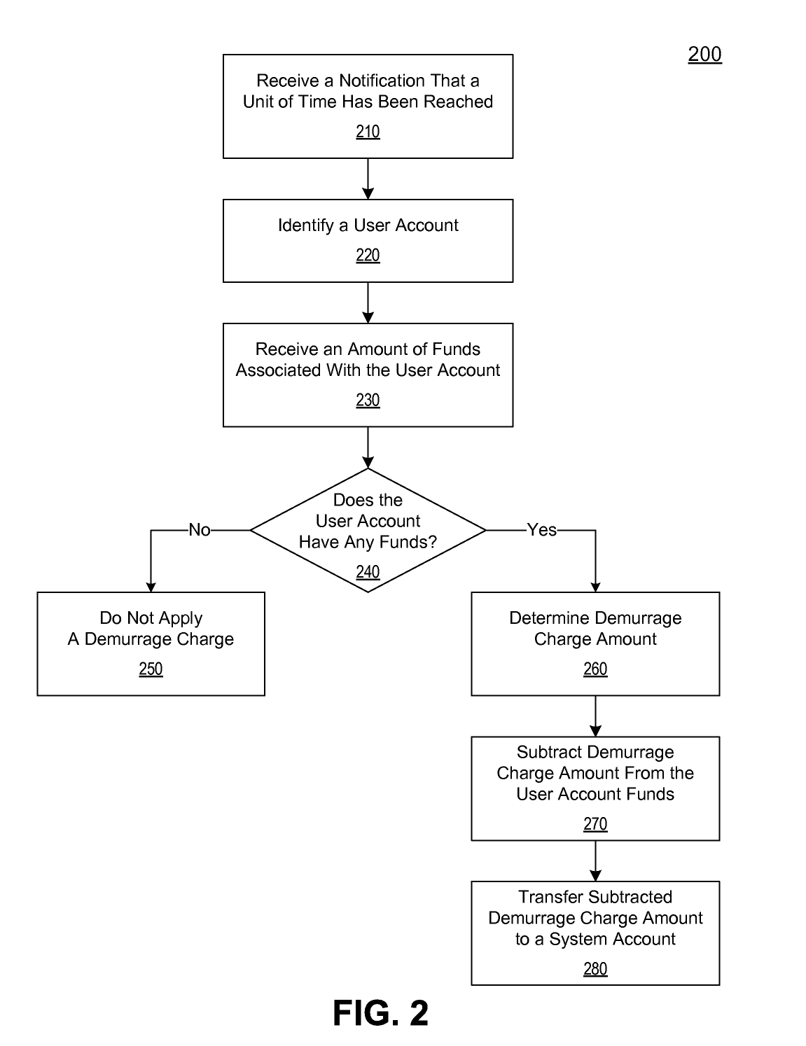

As seen in FIG. 1, at block 110, a transfer of funds may be received. In some embodiments, a user may transfer funds from an external account (e.g., a bank account that is not associated with the online payment system) to a user account associated with the online payment system. For example, a user may transfer an initial amount of funds from his or her bank account to a user account associated with the user. At block 120, the initial amount of funds received from the user's external account may be deposited into the user account. The user's account may reflect the addition of the initial amount of funds transferred by the user. As such, the user account may be associated with the initial amount of funds. At block 130, a determination may be made as to whether a unit of time (e.g., a discrete amount of time) has elapsed since the user received the funds. In some embodiments, the unit of time may comprise any measure of time (e.g., seconds, minutes, hours, days, weeks, months, etc.) and/or a particular date (e.g., a day of the week, first day of a month, two particular days of a month, etc.). If the unit of time has not been reached, then the online payment system may wait and/or monitor the funds in the user account until the unit of time has been reached. Once the unit of time has been reached, at block 140, a demurrage charge may be applied to the user account. In some embodiments, the application of the demurrage charge to the user account may comprise deducting the demurrage charge from the user account. For example, a demurrage charge may be calculated and subtracted from the user funds (or any amount of user funds) currently associated with the user account. Further details with regard to an online payment system with a demurrage charge are discussed with relation to FIGS. 2, 3, and 4.

FIG. 2 is a flow diagram of a method 200 to apply a demurrage charge to at least one user account of an online payment system in accordance with some embodiments. In general, the method 200 may determine a demurrage charge amount and transfer funds equivalent to the demurrage charge amount from a user account to a system account of the online payment system.

As seen in FIG. 2, at block 210, a notification may be received that a unit of time has been reached. In some embodiments, the unit of time may comprise a predefined time amount, day, and/or dates. For example, the unit of time may correlate to an elapsed amount of time (e.g., a period of elapsed time corresponding to an event such as a number of days elapsed since funds being deposited or transferred into a user account), a specific day and/or dates, etc. As such, an online payment system may determine and/or receive a notification that a predefined unit of time has been reached. At block 220, a user account may be identified. For example, an online payment system may identify a user account from a plurality of user accounts. At block 230, an amount of funds associated with the user account may be received. For example, the online payment system may determine and/or receive a notification of an amount of funds associated with the user account. As such, the online payment system may receive an amount of funds currently associated and/or deposited in the user account at the time of the unit of time being reached. At block 240, a determination may be made whether the identified user account has any funds associated with it at the time of the unit of time being reached.

As seen in FIG. 2, if the identified user account does not have any funds currently associated with or deposited in it, then at block 250, no demurrage charge may be applied to the user account. However, if the user account does have funds currently associated with it or deposited in it at the time of the unit of time being reached, then at block 260, a demurrage charge amount may be determined. In some embodiments, the demurrage charge may correspond to a cost and/or charge associated with holding currency. For example, the demurrage charge may comprise a cost for a user account to hold on to funds for and/or on the unit of time. As such, the demurrage charge may correspond to a carrying cost of money and/or funds associated with the user account. In some embodiments, the demurrage charge amount may be determined based on a percentage of the funds currently deposited in the user account at the time of the unit of time being reached. For example, the demurrage charge may be a percentage of the currently deposited funds in the user account when the unit of time is reached. For example, the demurrage charge may correspond to 0.25% of the current funds of the user account. For example, if the user account holds and/or is associated with $10,000, the demurrage charge amount may be $25 (e.g., 0.25% of $10,000). At block 270, the demurrage charge amount may be subtracted from the funds of the user account. In one embodiment, the online payment system may subtract the demurrage charge from the current funds associated with the user account at the time of the unit of time being reached. At block 280, the subtracted demurrage charge amount may be transferred from the user account to a system account of the online payment system. As such, the demurrage charge amount may be subtracted from the user account and added to the system account.

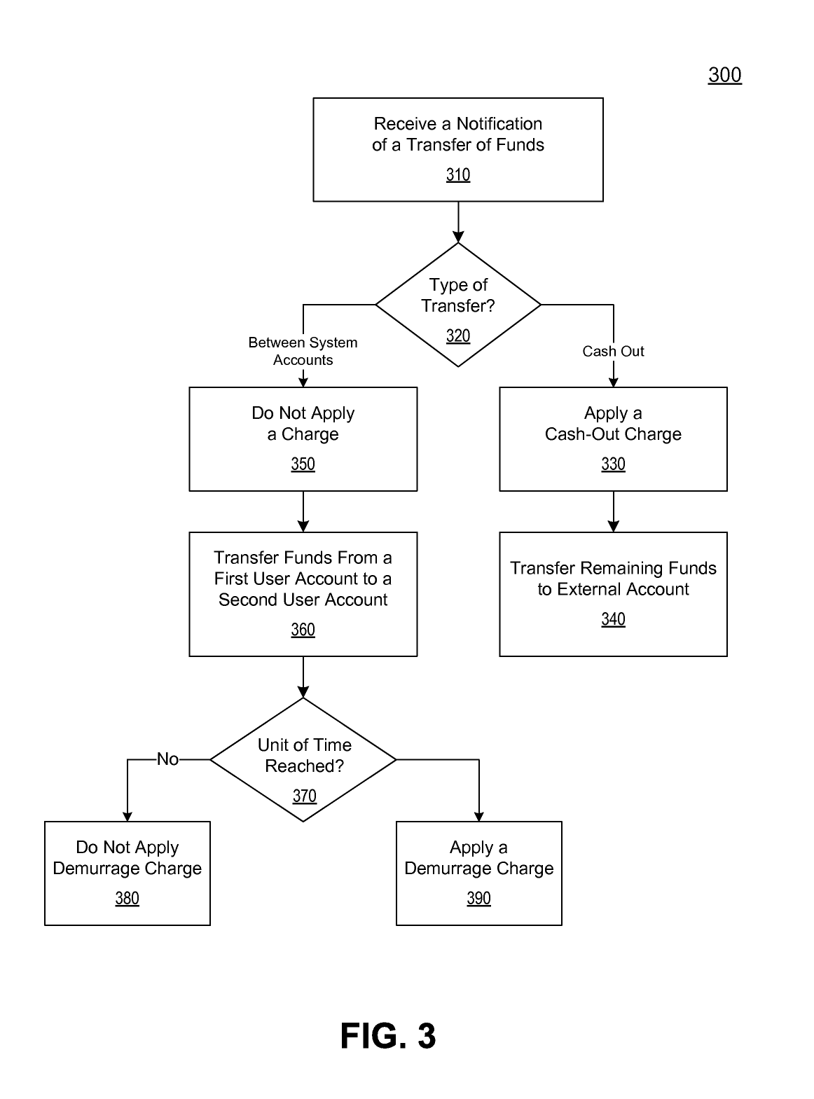

FIG. 3 illustrates a flow diagram of a method 300 for an online payment system comprising a demurrage charge and cash out charge in accordance with some embodiments of the disclosure. In general, the method 300 may receive and/or determine an event corresponding to a transfer of funds to an external account, a transfer of funds from a first user account of the online payment system to a second user account of the online payment system, and a unit of time being reached (e.g., the demurrage charge).

As seen in FIG. 3, at block 310, a notification of a transfer of funds may be received. For example, a notice of a transfer of funds from a first user account may be received. At block 320, a type of the transfer of funds from the first user account may be identified. In some embodiments, the type of transfer of funds may comprise a transfer of all or some of the funds currently in the user account to an external account not managed by the online payment system. For example, the transfer may comprise a transfer from the first user account to an external bank account of the user. If the type of transfer is a transfer from the first user account to an external account (e.g., a cash out of the funds from the first user account to the external account such that the funds are no longer associated with or in an account managed by the online payment system), then at block 330, a cash out charge may be applied to the funds. For example, the cash out charge may be applied to the amount of funds being transferred from the first user account to the external account. In some embodiments, the cash out charge amount may be determined based on a percentage of the funds being transferred from the first user account to the external account. In one embodiment, the cash out charge may be a percentage of the amount of funds being transferred from the first user account to the external account. For example, the cash out charge may correspond to 2.5% of the transferred funds. As such, if the user associated with the first user account is transferring funds at an amount of $10,000 to the external account, the cash out charge amount may be $250 (e.g., 2.5% of $10,000). At block 340, the remaining funds (e.g., the amount of funds remaining from the transferred funds after subtracting the cash out charge) may be transferred to the external account.

As seen in FIG. 3, if the type of transfer is a transfer of funds from a first user account of the online payment system to a second user account of the online payment system (e.g. between online payment system accounts), then at block 350, no charge may be applied to the transferred funds from the first user account to the second user account. At block 360, the transferred funds may be subtracted from the first user account and added to the second user account. As such, since there is no fee and/or charge applied to the transferring of the funds between system accounts, the second account may deposit the entire amount of the transferred funds from the first account. At block 370, a determination may be made as to whether a unit of time has been reached, as previously discussed with relation to FIGS. 1 and 2. If the unit of time has not been reached, then at block 380, no demurrage charge may be applied. However, if the unit of time has been reached, then at block 390, a demurrage charge may be applied. For example, the demurrage charge may be applied to the funds transferred from the first user account to the second user account if the transferred funds remain deposited in the second user account at the time of the unit of time being reached.

As such, an online payment system may charge various fees or costs based on a type of transfer or transaction. In some embodiments, a demurrage charge may be applied to funds currently deposited in user accounts of the online system at a particular time. A cash out transaction may result in a cash out charge being applied based on the amount of funds being transferred to an external account. However, no charge may be applied to a transfer between online payment system user accounts. In some embodiments, the cash out charge and/or fee may be higher than the demurrage charge and/or fee.

II. Advantages of an Online Payment System with a Demurrage Charge

Advantages of the online payment system with a demurrage charge, as discussed with relation to FIGS. 1-3, include, but are not limited to, an innovative fee structure that creates a marketplace that promotes the circulation of resources, networking between users and/or merchants, and a lack of a penalty or comparative disadvantage for users and/or merchants with less revenue than users and/or merchants with relatively larger revenue.

In some embodiments, the online payment system as discussed above integrates a demurrage charge and a cash-out charge to a base money payment system with a demurrage charge and a cash-out charge. For example, the online payment system may be more suitable for a knowledge based economy that benefits from networking and circulation of resources as well as an industrial based economy that benefits from economies of scale, large capital investments, and a more predictable supply.

In some embodiments, the online payment system may be operated for a marketplace (e.g., a group buying site or merchant) to collect sales revenue. In the same or alternative embodiments, such merchants may also be able to add their own surcharge component onto the demurrage and cash out charges of the online payment system. As such, each marketplace may potentially have its own currency associated with the online payment system where the operators of the online payment system may be able to adjust the monetary volume and velocity by adjusting surcharge fees. In some embodiments, users of the online payment system for such a merchant (e.g., the merchant's customers) may be notified beforehand (e.g., one month) before any such fee adjustment.

The adjustment of such fees may actively influence participants of an online market associated with the online payment system may encouraging buying behavior of the users of customers of the online market.

III. Online Payment System with Credit Notes

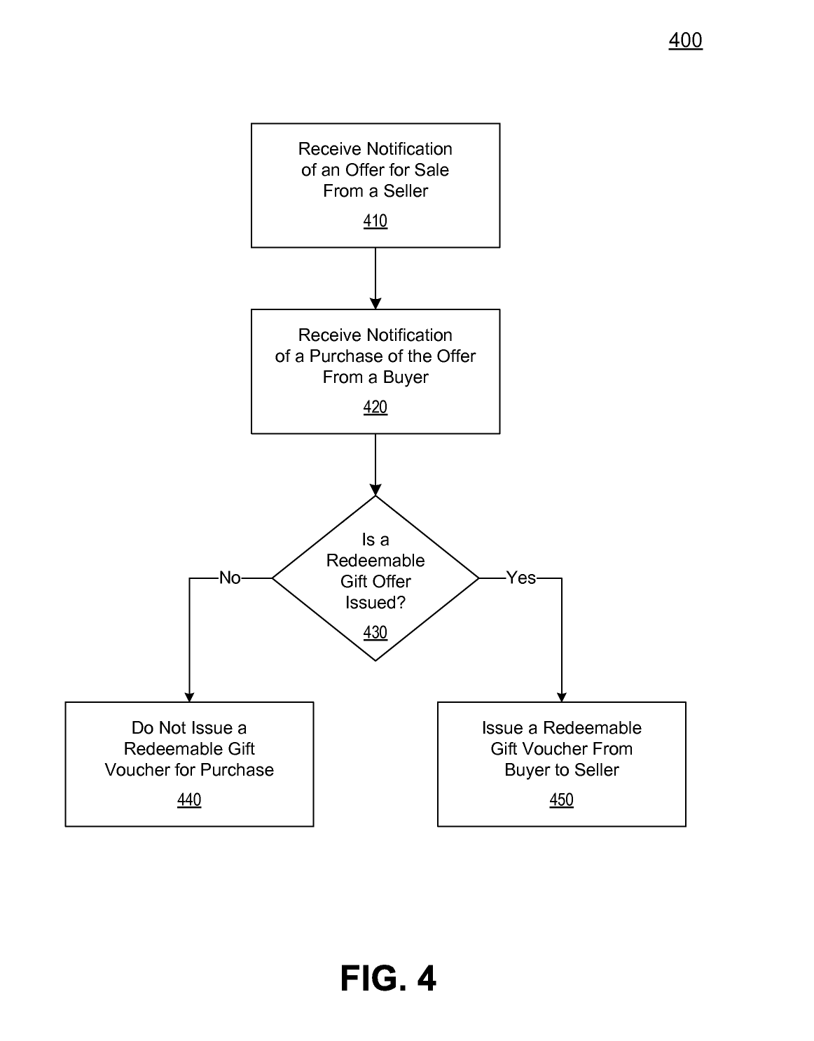

In some embodiments, the online payment system as disclosed herein may provide a peer-to-peer (e.g., from a first user account of the online payment system to a second user account of the online payment system) credit system. For example, the online payment system may be configured to allow a first user (e.g., a buyer) to issue a credit note to a second user (e.g., a seller from which the buyer is placing a purchase). FIGS. 4-7 disclose further details with regard to an online payment system with credit notes.

FIG. 4 is a flow diagram of a method 400 to issue a credit in the form of a redeemable voucher in accordance with some embodiments. In general, an online payment system may issue a credit and/or a redeemable voucher from a buyer to a seller in response to the buyer placing a purchase with the seller.

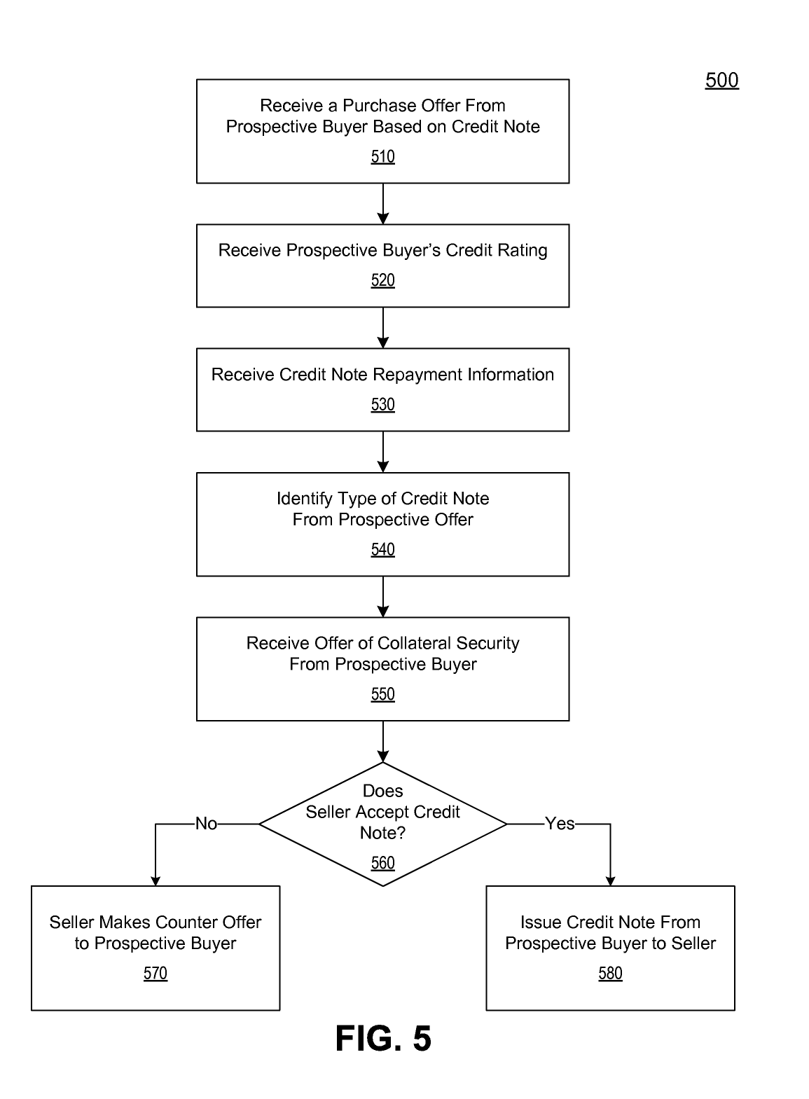

As seen in FIG. 4, at block 410, a notification of an offer for sale from a seller may be received. In some embodiments, the offer for sale may be for a product and/or a service associated with the seller. At block 420, a notification of a purchase of the offer for sale from the seller may be received. In some embodiments, a buyer may place a purchase for the offer from the seller. In the same or alternative embodiments, the buyer may purchase the product and/or service from the seller by using the online payment system to transfer a payment from the buyer's account associated with the online payment system to the seller's account associated with the online payment system. For example, the buyer may transfer funds from the buyer's account associated with the online payment system to the seller's account associated with the online payment system. In the same or alternative embodiments, the buyer may issue a credit and/or a redeemable voucher to purchase the goods and/or services from the seller. As such, a credit and/or redeemable voucher may be issued from the buyer's account of the online payment system to the seller's account of the online payment system. For example, if the buyer intends to make a purchase based on credit and/or a redeemable voucher, then at block 450, the online payment system may issue a credit and/or a redeemable voucher from the buyer to the seller. However, if the buyer doesn't make the purchase based on credit and/or the redeemable voucher, then at block 440, the online payment system does not issue a credit and/or redeemable voucher from the buyer to the seller. Further details with regard to credit and redeemable vouchers are discussed below with relation to FIGS. 5-7. In some embodiments, a credit or credit note may correspond to a redeemable voucher.

FIG. 5 illustrates a method 500 to issue a credit from a buyer to a seller in accordance with some embodiments of the disclosure. In general, the method 500 may receive and/or transmit information from a buyer to a seller such that the seller may accept a credit from the buyer.

As seen in FIG. 5, at block 510, an offer from a buyer to a seller to purchase with a credit note a good and/or service provided by the seller may be received. At block 520, a prospective buyer's credit rating may be received (e.g., transmitted to) a seller of the online payment system. In some embodiments, the credit rating may comprise a user's (e.g., buyer's) credit rating on the online payment system. For example, the credit rating may correspond to the buyer's reliability of meeting the obligations (e.g., debts and/or conditions) of prior credit notes issued by the online payment system for the buyer. As such, the buyer's credit rating may correspond to the buyer's historical behavior on the online payment system of meeting the obligations and conditions of prior issued credit notes to one or more sellers. In some embodiments, if a user is associated with a low credit rating (e.g., a credit rating below a threshold value), the user may not be able to issue a credit note on the online payment system. At block 530, credit note repayment information may be received (e.g., transmitted to) the seller of the online payment system. In some embodiments, the credit note repayment information may comprise obligations and/or conditions of the credit note of the buyer. For example, the credit note repayment information may specify an amount of money that the buyer will pay to the seller (e.g., the buyer depositing into the online payment account of the seller) for the purchase of the good and/or service provided by the seller and a repayment date relating to a deadline as to when the buyer will provide the payment to the seller. As such, a credit note may comprise a redemption amount and a redemption deadline date.

As seen in FIG. 5, at block 540, a type of credit note offered from the buyer may be identified and/or transmitted to the seller. In some embodiments, the online payment system may enable a buyer to transfer and/or issue a plurality of types of credit notes to sellers. For example, an online payment system may allow the buyer to transfer and/or issue his or her own credit note to a seller, transfer a credit note that the buyer has acquired from another user of the online payment system (e.g., the another user issued his or her own credit note to the buyer) to the seller, and/or an insured credit note. In some embodiments, the insured credit note may be insured by the online payment system itself or a third party insurance (e.g., through a third party underwriter). In the same or alternative embodiments, a merchant (e.g., a buyer and/or a seller) may obtain credit default insurance in the event that a buyer who issues a credit note to the seller is unable to meet the obligations and conditions of the credit note. The credit default insurance may be provided by the operator of the online payment system, a third party insurer, or a group of users (e.g., sellers) grouping together as a mutual insurance company. In some embodiments, a user (e.g., a seller or merchant) may be allowed to have a certain value or amount of outstanding (e.g., uncollected payments from buyers who have issued the credit notes) insured credit notes. For example, an insurer (e.g., the operator of the online payment system, third party insurer, etc.) may specify a maximum dollar amount that will be insured for a particular user who obtains insurance for the credit notes, a maximum time period between issuing the credit notes and redemption of the payment associated with the credit notes (e.g., requiring users who obtain credit note insurance to ensure that any credit notes issued from a buyer to the user obtaining insurance comprises a redemption date limit), or any other restrictions.

At block 550 of the method 500 of FIG. 5, an offer of collateral security associated with the credit note from the buyer may be received and/or transmitted to the seller. At block 560, the seller may accept or not accept the credit note from the buyer. For example, a set of rules from the seller may be used to process the information from blocks 510, 520, 530, 540, and/or 550 to determine whether the buyer's credit note will be accepted by the seller. If the seller does accept the credit note from the buyer, then at block 580, the online payment system may issue a credit note from the buyer to the seller. However, if the seller does not accept the credit note from the buyer, then at block 570, the seller may make a counteroffer to the buyer. For example, the seller may demand different credit note terms (as previously discussed) from the buyer.

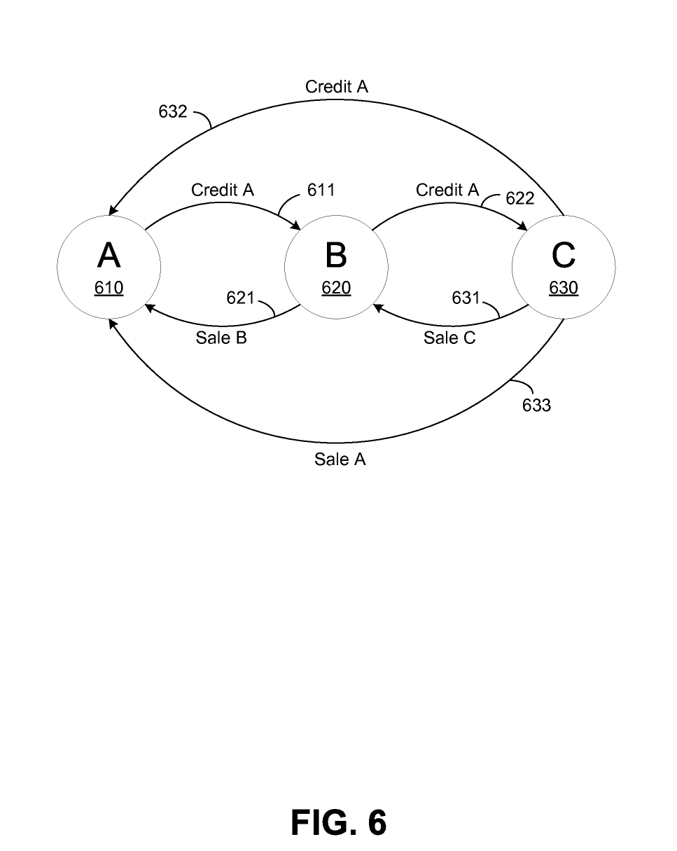

FIG. 6 is an example of transfer of credits in accordance with some embodiments of the disclosure. In general, an online payment system may enable a plurality of users to issue credit notes and the transfer of the credit notes in order to satisfy user debts from the issuance of the credit notes.

As seen in FIG. 6, an online payment system may comprise a plurality of users. In some embodiments, each user of the online payment system is associated with his or her own user account which may be used to hold, transfer, and/or deposit funds or money and to issue credit notes as previously discussed with relation to FIG. 5. As such, the online payment system may enable a plurality of users to each issue a plurality of credit notes to other users. For example, a user 610 (A) may be a buyer of a product and/or service associated with the online payment system. For example, the user A may purchase a product and/or service from a user 620 (B). In a first transaction, the user A may be a buyer and the user B may be a seller such that the user A issues a credit note to B (e.g., transaction 611) for a sale of a good and/or service from user B (e.g., transaction 621). For this example, the online payment system has issued a credit note from user A to user B and the credit note is deposited or associated with the user B account. In some embodiments, the user B may then purchase a good and/or service from another seller by using the credit note obtained in the sale to user A. For example, the user B may purchase a good and/or service from user 630 (C). As such, in a second transaction, the user B may now be a buyer and the user C may be a seller such that the user B transfers the credit A obtained from the sale to user A (e.g., transaction 622) for a sale of a good and/or service from user C (e.g., transaction 631). Thus, the online payment system has transferred the credit note originally issued from user A that was associated with the account of user B to the account associated with user C. As such, the user B has made a purchase from user C by using a third party (e.g., user A) credit note.

In some embodiments, the online payment system may identify a network of debt obligations or credit notes between a plurality of users such that a user may accept a purchase offer from a buyer in order to satisfy the user's own debt obligations through credit notes. For example, as previously discussed, user A may issue a credit note to user B, whereby user B may transfer the credit note from user A to user C. Thus, the credit note issued by user A has been transferred to user C, despite that user A has not entered into any transactions (e.g., purchases or sales) with user C. In some embodiments, user A may make an offer for sale and the user C who now has the credit note from user A may make a purchase offer to the user A. In the same or alternative embodiments, the user C may indicate that he or she wishes to make the purchase offer with the credit note from user A that the user C obtained from the sale with user B. For example, the online payment system may indicate to user A that he or she has an outstanding debt obligation in the form of the credit note (originally issued to user B) with the user C. As such, if the user A accepts the purchase offer from the user C, the user A may be able to cancel out his or her own debt by accepting the purchase offer with the payment from the credit note originally issued by user A to user B. Thus, such a credit note arrangement would have zero risk for user A since user A would be canceling his or her own debt by accepting the purchase offer from user C. As such, a seller may cancel his or her existing debt obligations by accepting sales from users that the online payment system has identified as holding a credit note originally issued by the seller when the seller made a purchase transaction.

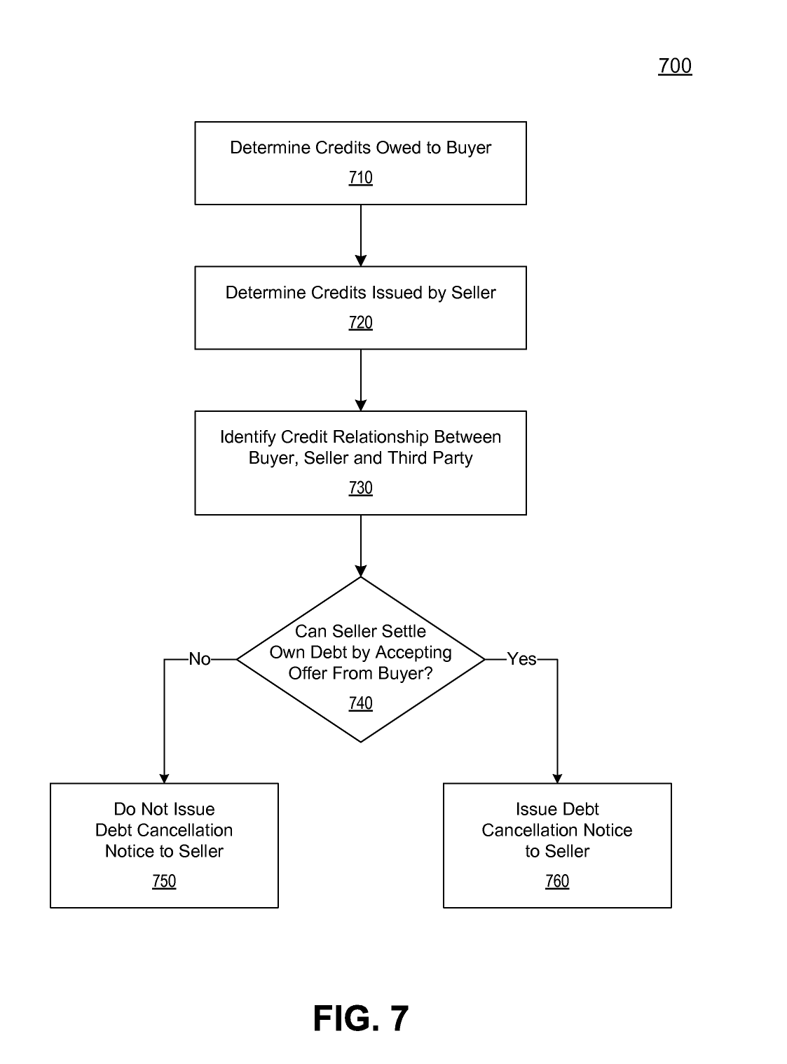

FIG. 7 is a flow diagram of a method 700 to determine debt relationships in accordance with some embodiments. In general, the method 700 may identify a network of credit or debt relationships between a plurality of users of an online payment system such that a credit relationship between a buyer and a seller may be identified.

As seen in FIG. 7, at block 710, credits owed to a first user (e.g., a buyer) may be determined and/or identified. For example, the first user may have sold goods and/or services and received credit notes from a second user and other users. At block 720, credit notes issued by a second user (e.g., a seller) may be determined and/or identified. For example, the second user may have purchased goods and/or services and issued credit notes for users who offered for sale the purchased goods and/or services. At block 730, a credit note relationship between the buyer and seller (as well as other third party users) may be identified or determined. At block 740, a determination may be made as to whether the seller may be able to settle his or her own debt by accepting an offer made from a seller. If no such credit relationship exists, then at block 750, a debt cancellation notice may not be issued to the seller. However, if the seller may be able to cancel at least a portion of his or her outstanding debt obligations on the online payment system, then at block 760, a debt cancellation notice may be issued to the seller.

IV. Advantages of Online Payment System with Credit Notes

Advantages of the online payment system with credit notes, as discussed with relation to FIGS. 4-7, include, but are not limited to, providing a peer-to-peer (e.g., between users) credit system that may be an alternative to immediate base money payments. For example, a site for a merchant may include an option where credit notes or purchases may be considered such that prospective buyers may click on the button and specify or request purchase agreements (e.g., credit note obligations) that the buyers would prefer.

In some embodiments, the credit notes may be in the form of redeemable vouchers that can be redeemed at any time for products and/or services offered by a user who has issued a credit note. As such, credit notes may easily be swapped between users since credit note issuers may be more likely to accept their own credit notes for products and/or services offered by themselves. As such, a marketplace for redeemable vouchers or credit notes may be created such that users may sell or trade credit notes before a redemption date. Moreover, merchants may offer discounts to purchases made with such redeemable vouchers or credit notes. For example, merchants may give a discount on purchases made with redeemable vouchers or credit notes that are redeemable on the month that the purchase is made.

Thus, credit notes (e.g., redeemable vouchers) may allow users who hold such credit notes a plurality of options. For example, users may hold the credit note and redeem the credit note for money at the redemption date. Alternatively, users may use the credit note as a redeemable voucher at any time to purchase goods from the user who has issued the credit note. Moreover, a secondary market operated by the online payment system may be created where users may sell credit notes before the redemption date. Furthermore, users may pay other users with the credit notes obtained from others if the seller is willing to accept the credit note. Furthermore, users may swap or trade credit notes or make payments to a seller based on a credit note (e.g., part of a payment with money and part of the payment with a credit note).

In some embodiments, the online payment system with credit notes may also enable merchants to group together and each other's credit notes under a common endorsing brand. For example, a plurality of merchants (e.g., sellers) may each accept credit notes issued under the common endorsing brand.

In some embodiments, the online payment system with credit notes may further encourage free credit arrangements. For example, while funds deposited in a user account may be subjected to demurrage charges as previously discussed, credit notes may not be subject to such demurrage charges. However, the online payment system may charge a transaction fee for credit note transfers between users.

Further embodiments of an online payment system with credit notes may be used to facilitate an online payment platform based on various policies. For example, an online payment platform following Islamic economic law may be implemented. In such an embodiment, credit notes (e.g., a redeemable gift voucher) may only be exchanged at a one to one par value (e.g., face value). As such, a first credit note and a second credit note may only be exchanged at the originally issued value, even if the first credit note and the second credit note were issued by different merchants. However, the online payment system may be configured to allow a seller to negotiate a different sale price based on an evaluation of a credit note being received from a buyer in exchange for a sale (e.g., the seller may modify the sale price based on the credit note being offered when accepting third party credit notes for the sale). In some embodiments, the seller's evaluation of a credit note may be based on credit note features such as the range of items that may be purchased by the credit note (e.g., redeemable voucher), redemption date, the credit worthiness of the issuer of the credit note (e.g., likelihood of the issuer remaining as a merchant on the online payment system), etc. As such, a seller accepting credit notes in return for a sale of an item may receive a company's economic health or condition, finances, outstanding credit notes, issues and/or used credit notes in a month, etc. of the user with the credit note. A seller may manipulate or change the selling price of an item based on the information related to the credit note being offered by the buyer.

As such, a difference in value of credit notes may effectively be implemented at the point of sale (e.g., accepting of a previously issued credit note) rather than at the exchanging of the first credit note for the second credit note.

In some embodiments, credit notes may be pegged to a first currency (e.g., denominated in United States dollars). In the same or alternative embodiments of an online payment system, the value of the credit note may be pegged or denominated to another store of value (e.g., a second currency, a unit of commodities, etc.). In some embodiments, credit notes may be re-denominated to another store or measure of value (e.g., another denomination). For example, an issuer of credit notes may associate each of the issued credit notes with a provision that the value of the credit note may be changed from a first denomination to a second denomination. In some embodiments, the changing of the value of a credit note from the first denomination to the second denomination may involve the calculating of an exchange rate between the denominations and then calculating the value of the credit note based on the exchange rate. In some embodiments, if an issuer of credit notes re-denominates credit notes issued by the issuer, then all outstanding credit notes issued by the issuer may be re-denominated. In some embodiments, a credit note issued in a first denomination may only be exchanged with a credit note in the same denomination. As such, if a credit note is valued at a first denomination (e.g., United States dollars), then the credit note cannot be exchanged with a second credit note valued at a second denomination (e.g., British pounds). As such, a plurality of forms of money (e.g., credit notes issued in a plurality of types of denominations) may be issued and used in an online payment system.

V. Operating Environments of the Disclosure

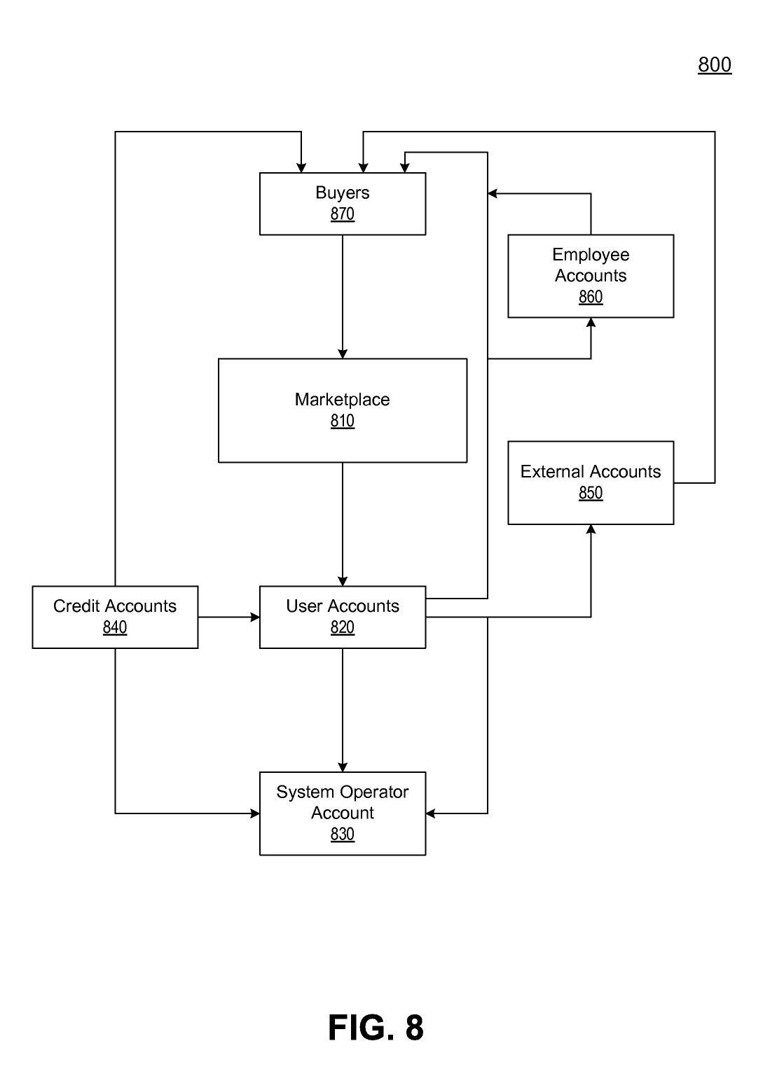

FIG. 8 illustrates an example of an online payment system environment 800 within which some embodiments of the disclosure are implemented. In general, the online payment system environment 800 comprises a marketplace where buyers may make transactions (e.g., purchases or sales) where the funds associated with the transactions are placed into online user accounts managed by the online payment system.

As seen in FIG. 8, a marketplace 810 may allow a plurality of buyers 870 to place transactions with each other. For example, the transactions may be between any users of the online payment system. In some embodiments, the buyers 870 may make the transactions by using credit notes from a credit account 840, from a user account 820 managed by the online payment system, or an external account 850 that is not managed by the online payment system (e.g., a conventional fractional reserve bank such as a user's external conventional bank account). As such, buyers 870 may pay for a transaction at the marketplace 810 by using credit notes, funds from a user account managed by the online payment system, or funds from an external account. In some embodiments, funds received to pay for transactions may be deposited into the user accounts 820. For example, funds received from other user accounts or from an external account may be deposited into a user account 820. In some embodiments, funds deposited in the user accounts 820 may be subject to a demurrage charge and/or a cash out charge as previously discussed. For example, a demurrage charge may be applied to the funds deposited in the user accounts 820 and the collected demurrage charge from the user accounts 820 may be transferred to a system operator account 830. In some embodiments, the system operator account 830 is associated with the operator of the online payment system. In the same or alternative embodiments, the system operator account 830 may be associated with the operator of the marketplace 810. As such, the system operator account 830 may collect charges and/or fees for the online payment system and/or the marketplace 810.

As seen in FIG. 8, credit accounts 840 may be used to pay for transactions at the marketplace 810. For example, the credit accounts 840 may each be associated with a single user of the online payment system 800. In some embodiments, the credit accounts 840 may comprise various types of credit notes (e.g., uninsured, insured, etc.). The credit notes of the credit accounts 840 may comprise a redemption date and an amount of funds that must be paid by the redemption date. In some embodiments, such a credit arrangement may require the depositing of the amount of funds into a corresponding user account 820 (e.g., into the user account of the user who holds the credit note). In the same or alternative embodiments, a default of a credit note (e.g., a user who issues a credit note not meeting the obligations and/or conditions of the credit note) may be charged a credit default insurance fee that is transferred to the system operator account 830. A credit rating charge may also be charged to the credit accounts 840 to be collected by the system operator account 830.

In some embodiments, funds currently deposited in the user accounts 820 may be transferred to an external account 850 of a particular user. For example, a user may move funds out of the online payment system 800 to an external account 850 that is not controlled by the online payment system 800. In some embodiments, a transfer of funds to an external account 850 may be subject to a cash out charge that comprises a fee that is transferred from the funds of the user accounts 820 to the system operator account 830. In some embodiments, employee accounts 860 may be available such that a merchant (e.g., a user of the online payment system connected to the marketplace 810) may transfer money from the merchant's own user account 820 to the employee accounts 860. In some embodiments, such transfers between user accounts of the online payment system are not subject to a fee. The funds in the employee accounts 860 may then be used to place purchases within the marketplace 810.

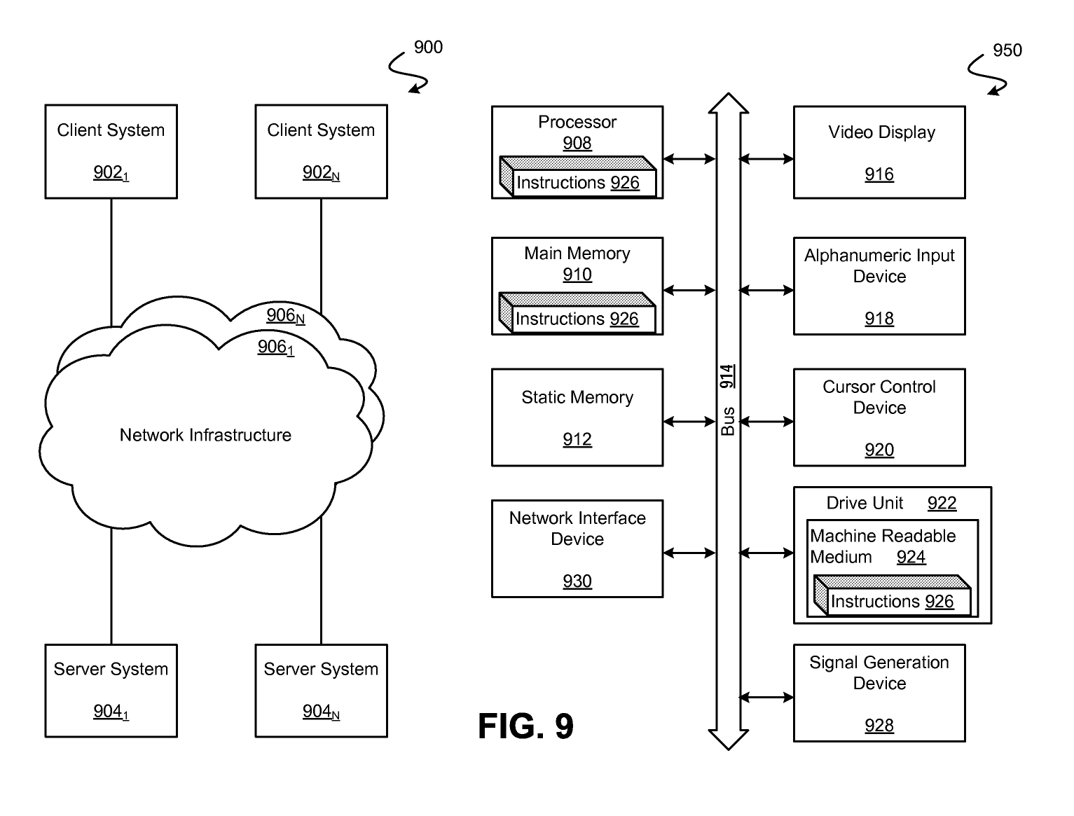

FIG. 9 is a diagrammatic representation of a network 900, including nodes for client computer systems 902₁ through 902_{N}, nodes for server computer systems 904₁ through 904_{N}, nodes for network infrastructure 906₁ through 906_{N}, any of which nodes may comprise a machine 950 within which a set of instructions for causing the machine to perform any one of the techniques discussed above may be executed. The embodiment shown is purely exemplary, and might be implemented in the context of one or more of the figures herein.

Any node of the network 900 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 950 includes a processor 908 (e.g. a processor core, a microprocessor, a computing device, etc.), a main memory 910 and a static memory 912, which communicate with each other via a bus 914. The machine 950 may further include a display unit 916 that may comprise a touch-screen, or a liquid crystal display (LCD), or a light emitting diode (LED) display, or a cathode ray tube (CRT). As shown, the computer system 950 also includes a human input/output (I/O) device 918 (e.g., a keyboard, an alphanumeric keypad, etc.), a pointing device 920 (e.g., a mouse, a touch screen, etc.), a drive unit 922 (e.g. a disk drive unit, a CD/DVD drive, a tangible computer readable removable media drive, an SSD storage device, etc.), a signal generation device 928 (e.g. a speaker, an audio output, etc.), and a network interface device 930 (e.g. an Ethernet interface, a wired network interface, a wireless network interface, a propagated signal interface, etc.).

The drive unit 922 includes a machine-readable medium 924 on which is stored a set of instructions (i.e. software, firmware, middleware, etc.) 926 embodying any one, or all, of the methodologies described above. The set of instructions 926 is also shown to reside, completely or at least partially, within the main memory 910 and/or within the processor 908. The set of instructions 926 may further be transmitted or received via the network interface device 930 over the network bus 914.

It is to be understood that embodiments of this disclosure may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

What is claimed is:

1. A method for operating an online payment system, the method comprising:
identifying a user account associated with a first amount of funds;
determining, by a computer, if a unit of time has been reached;
calculating, if the unit of time has been reached, a demurrage charge for the user account, the demurrage charge is at least partly based on a percentage of the first amount of funds; and
subtracting the demurrage charge from the first amount of funds of the user account.

2. The method of claim 1, further comprising:
transferring the subtracted demurrage charge from the user account to a system account associated with an administrator of the online payment system.

3. The method of claim 1, further comprising:
receiving a notice to transfer the first amount of funds from the user account to an external account;
determining a transfer charge to transfer the first amount of funds to the external account; and
subtracting the transfer charge from the first amount of funds to calculate an amount of funds to transfer to the external account.

4. The method of claim 3, wherein the transfer charge is larger than the demurrage charge.

5. The method of claim 1, further comprising:
receiving a request to transfer funds from the user account to a second account, wherein a transfer charge is applied to the transfer of funds if the second account is an external account not controlled by the online payment system and no charge is applied to the transfer of funds if the second account is an account controlled by the online payment system.

6. The method of claim 1, wherein the unit of time comprises a particular date.

7. The method of claim 1, wherein the unit of time comprises an amount of time that the first amount of funds has been deposited in the user account.

8. A non-transitory computer readable medium storing one or more instructions to control an online payment system, wherein the one or more instructions, when executed by one or more processors, causes the one or more processors to perform the steps of:
identifying a user account associated with a first amount of funds;
determining if a unit of time has been reached;
calculating, if the unit of time has been reached, a demurrage charge for the user account, the demurrage charge is at least partly based on a percentage of the first amount of funds; and
subtracting the demurrage charge from the first amount of funds of the user account.

9. The non-transitory computer readable medium of claim 8, the steps further comprising:
transferring the subtracted demurrage charge from the user account to a system account associated with an administrator of the online payment system.

10. The non-transitory computer readable medium of claim 8, the steps further comprising:
receiving a notice to transfer the first amount of funds from the user account to an external account;
determining a transfer charge to transfer the first amount of funds to the external account; and
subtracting the transfer charge from the first amount of funds to calculate an amount of funds to transfer to the external account.

11. The non-transitory computer readable medium of claim 10, wherein the transfer charge is larger than the demurrage charge.

12. The non-transitory computer readable medium of claim 8, further comprising:
receiving a request to transfer funds from the user account to a second account, wherein a transfer charge is applied to the transfer of funds if the second account is an external account not controlled by the online payment system and no charge is applied to the transfer of funds if the second account is an account controlled by the online payment system.

13. The non-transitory computer readable medium of claim 8, wherein the unit of time comprises a particular date.

14. The non-transitory computer readable medium of claim 8, wherein the unit of time comprises an amount of time that the first amount of funds has been deposited in the user account.

15. A system, comprising at least one processor and memory, to control an online payment system, the system comprising:
a module to identify a user account associated with a first amount of funds;
a module to determine if a unit of time has been reached;
a module to calculate, if the unit of time has been reached, a demurrage charge for the user account, the demurrage charge is at least partly based on a percentage of the first amount of funds; and
a module to subtract the demurrage charge from the first amount of funds of the user account.

16. The system of claim 15, further comprising:
a module to transfer the subtracted demurrage charge from the user account to a system account associated with an administrator of the online payment system.

17. The system of claim 15, further comprising:
a module to receive a notice to transfer the first amount of funds from the user account to an external account;
a module to determine a transfer charge to transfer the first amount of funds to the external account; and
a module to subtract the transfer charge from the first amount of funds to calculate an amount of funds to transfer to the external account.

18. The system of claim 17, wherein the transfer charge is larger than the demurrage charge.

19. The system of claim 15, further comprising:
a module to receive a request to transfer funds from the user account to a second account, wherein a transfer charge is applied to the transfer of funds if the second account is an external account not controlled by the online payment system and no charge is applied to the transfer of funds if the second account is an account controlled by the online payment system.

20. The system of claim 15, wherein the unit of time comprises a particular date.
